(19) United States
(12) Patent Application Publication
(10) Pub. No.: US 2017/0244805 A1
(43) Pub. Date: Aug. 24, 2017

(54) SYSTEMS AND METHODS FOR COORDINATING EVENTS

(71) Applicant: Facebook, Inc., Menlo Park, CA (US)

(72) Inventors: David Thomas Callies, Cambridge, MA (US); Christopher William Dentel, Seattle, WA (US)

(21) Appl. No.: 15/051,442

(22) Filed: Feb. 23, 2016

(51) Int. Cl. H04L 29/08; H04L 12/58

(52) U.S. Cl. CPC H04L 67/306; H04L 51/32

(57) ABSTRACT

Systems, methods, and non-transitory computer-readable media can obtain a set of configuration options for an event, the configuration options specifying information for grouping users that are participating in the event. A determination is made that a set of users have confirmed their participation in the event. Each user in the set is assigned to a respective group based at least in part on one or more criteria specified in the configuration options for the event. Each user assigned to a group is provided with information describing at least their respective group.

### FIELD OF THE INVENTION

The present technology relates to the field of event scheduling. More particularly, the present technology relates to techniques for assigning users to groups.

### BACKGROUND

Today, people often utilize computing devices (or systems) for a wide variety of purposes. Users can use their computing devices to, for example, interact with one another, access content, share content, and create content. In some cases, users can use their computing devices to reserve resources. For example, a user may use a computing device to schedule meetings over some period of time.

### SUMMARY

Various embodiments of the present disclosure can include systems, methods, and non-transitory computer readable media configured to obtain a set of configuration options for an event, the configuration options specifying information for grouping users that are participating in the event. A determination is made that a set of users have confirmed their participation in the event. Each user in the set is assigned to a respective group based at least in part on one or more criteria specified in the configuration options for the event. Each user assigned to a group is provided with information describing at least their respective group.

In an embodiment, the configuration options specify one or more of: a geographic location at which the event is being held, a number of users to include in a group, one or more days on which the event is held, how frequently the event is held, and at least one approach for assigning users to groups.

In an embodiment, the systems, methods, and non-transitory computer readable media are configured to send a calendar invite for the event to each user that has opted-in to attend the event and determine the set of users that have accepted their respective calendar invite.

In an embodiment, the systems, methods, and non-transitory computer readable media are configured to assign at least one user having a first job title with at least one user having a second job title to the same group.

In an embodiment, the systems, methods, and non-transitory computer readable media are configured to assign at least one user having a first duration of employment with an organization with at least one user having a second duration of employment with the organization to the same group.

In an embodiment, the systems, methods, and non-transitory computer readable media are configured to determine respective interests for at least some of the users in the set based at least in part on information provided in the respective social networking profiles of the users and assign at least one first user and at least one second user having at least one matching interest to the same group.

In an embodiment, the systems, methods, and non-transitory computer readable media are configured to determine respective social affinity scores between at least some of the users in the set based at least in part on a social graph managed by the social networking system and assign at least one first user and at least one second user having at least one a threshold social affinity score to the same group.

In an embodiment, the systems, methods, and non-transitory computer readable media are configured to determine that at least one first user and at least one second user have previously been assigned to the same group and assign the at least one first user to a group that is different from a group to which the at least one second user is assigned.

In an embodiment, the systems, methods, and non-transitory computer readable media are configured to determine that at least one first user and at least one second user are employees that work in the same department and assign the at least one first user to a group that is different from a group to which the at least one second user is assigned.

In an embodiment, the systems, methods, and non-transitory computer readable media are configured to updating respective calendar entries for the event that were accepted by the set of users, wherein a calendar entry of a user is updated to include information describing the respective group to which the user was assigned.

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the disclosed technology.

### BRIEF DESCRIPTION OF THE DRAWINGS

FIG. 1 illustrates an example system including an example scheduling module, according to an embodiment of the present disclosure.

FIG. 2 illustrates an example of a meeting module, according to an embodiment of the present disclosure.

FIG. 3 illustrates an example of a grouping module, according to an embodiment of the present disclosure.

FIG. 4 illustrates an example interface for configuring an event, according to various embodiments of the present disclosure.

FIG. 5 illustrates an example process for assigning users to groups, according to various embodiments of the present disclosure.

FIG. 6 illustrates a network diagram of an example system including an example social networking system that can be utilized in various scenarios, according to an embodiment of the present disclosure.

FIG. 7 illustrates an example of a computer system or computing device that can be utilized in various scenarios, according to an embodiment of the present disclosure.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

### Approaches for Coordinating Events

Today, people often utilize computing devices (or systems) for a wide variety of purposes. Users can use their computing devices to, for example, interact with one another, access content, share content, and create content. In some instances, a meeting organizer may use a software application running on a computing device to create, or schedule, meetings through a calendaring system. For example, when creating the meeting, the user can provide the names (e.g., e-mail addresses) of any attendees to be invited to the meeting, the time period during which the meeting will occur, dial-in information for invitees that will be teleconferencing, and one or more locations at which the meeting will be held. Once the meeting has been created, the calendaring system will typically add a calendar entry that corresponds to the meeting in the calendar of the meeting organizer. Users that were specified as attendees of the meeting will typically receive electronic invitations for the meeting. Once these invitations are accepted, the calendar entry will typically be inserted in the calendars of each of the users that accepted the meeting invite. Under conventional approaches, users are typically required to determine who to invite to their meeting. Such conventional approaches, therefore, are not suitable for coordinating networking events, or meetings, between various users that may not be familiar with one another. Accordingly, such conventional approaches may not be effective in addressing these and other problems arising in computer technology.

An improved approach rooted in computer technology overcomes the foregoing and other disadvantages associated with conventional approaches specifically arising in the realm of computer technology. In various embodiments, one or more administrators can configure and/or manage events for which users are assigned to groups, for example, for the purposes of meeting new people, networking, or participating in a group activity. Such events can be hosted, for example, among employees of an organization, among employees that are located at one or more campuses of the organization, individuals that are associated with a club or interest-based group, or among any set of individuals. One example of an event involves assigning company employees to lunch groups to encourage those employees to meet and network with other employees. When configuring this event, an administrator can define a minimum or maximum size limit for lunch groups, a meeting time, days of the week during which such meetings occur (e.g., Friday), and how frequently such meetings occur (e.g., weekly, bi-weekly, monthly, etc.). Company employees can opt-in to this event. Once opted-in, the employees are automatically placed into a pool of users from which the lunch groups can be formed. Users that are included in a group can be instructed to meet one another at a designated time and geographic location. The approaches used for pairing, or assigning, users to the groups can vary depending the implementation. In one example, users can be grouped based on their job seniority. For example, a user that has been at a company for more than 10 years can be grouped with one or more users that have been at the company for less than 2 years. Naturally, meetings between users is not limited to lunch groupings and such meetings can be coordinated for any type of activity.

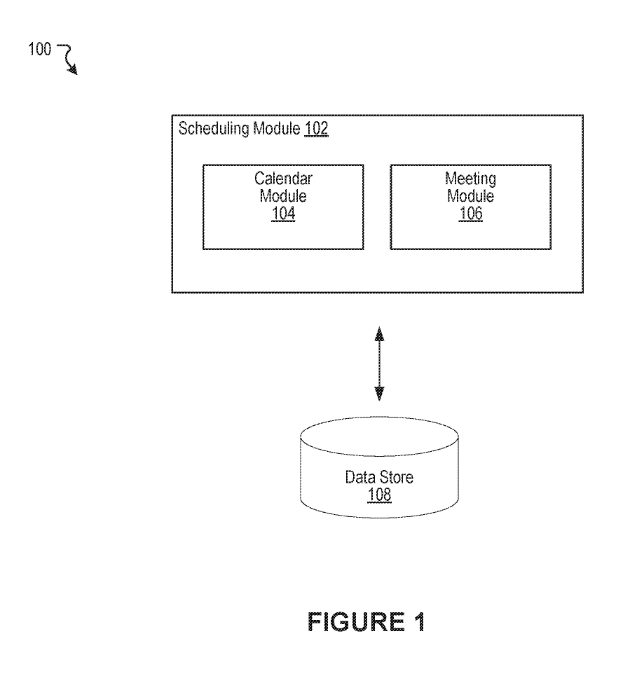

FIG. 1 illustrates an example system 100 including an example scheduling module 102, according to an embodiment of the present disclosure. As shown in the example of FIG. 1, the scheduling module 102 can include a calendar module 104 and a meeting module 106. In some instances, the example system 100 can include at least one data store 108. The components (e.g., modules, elements, etc.) shown in this figure and all figures herein are exemplary only, and other implementations may include additional, fewer, integrated, or different components. Some components may not be shown so as not to obscure relevant details.

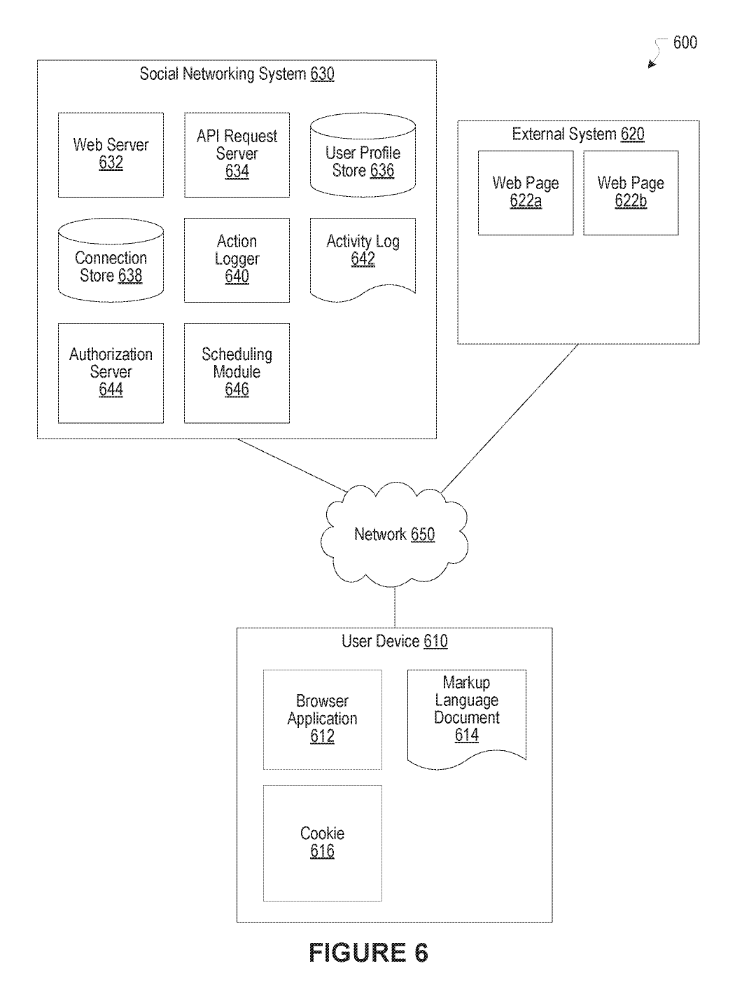

In some embodiments, the scheduling module 102 can be implemented, in part or in whole, as software, hardware, or any combination thereof. In general, a module as discussed herein can be associated with software, hardware, or any combination thereof. In some implementations, one or more functions, tasks, and/or operations of modules can be carried out or performed by software routines, software processes, hardware, and/or any combination thereof. In some cases, the scheduling module 102 can be implemented, in part or in whole, as software running on one or more computing devices or systems, such as on a user or client computing device. In one example, the scheduling module 102 or at least a portion thereof can be implemented as or within an application (e.g., app), a program, or an applet, etc., running on a user computing device or a client computing system, such as the user device 610 of FIG. 6. In another example, the scheduling module 102 or at least a portion thereof can be implemented using one or more computing devices or systems that include one or more servers, such as network servers or cloud servers. In some instances, the scheduling module 102 can, in part or in whole, be implemented within or configured to operate in conjunction with a social networking system (or service), such as the social networking system 630 of FIG. 6.

The scheduling module 102 can be configured to communicate and/or operate with the at least one data store 108, as shown in the example system 100. The at least one data store 108 can be configured to store and maintain various types of meeting data. For example, the data store 108 can store information describing meetings that were scheduled and which users were participants of those meetings. In some implementations, the at least one data store 108 can store information associated with the social networking system (e.g., the social networking system 630 of FIG. 6). The information associated with the social networking system can include data about users, social connections, social interactions, locations, geo-fenced areas, maps, places, events, pages, groups, posts, communications, content, feeds, account settings, privacy settings, a social graph, and various other types of data. In some implementations, the at least one data store 108 can store information associated with users, such as user identifiers, user information, profile information, user specified settings, content produced or posted by users, and various other types of user data.

The calendar module 104 can be configured to interact with a calendaring system through which meetings can be scheduled. The calendaring system can maintain a separate calendar for each user. The meeting module 106 can coordinate meetings through the calendaring system using the calendar module 104 based on various specified parameters. For example, the meeting module 106 can create, or schedule, a meeting through the calendaring system by providing the names (e.g., e-mail addresses) of the attendees to be invited to the meeting, the meeting time period, and one or more locations at which the attendees are to meet. The calendar module 104 can interact with the calendaring system to create a calendar entry based in part on the specified parameters. The calendar module 104 can also be configured to update such calendar entry with new information (e.g., meeting time, meeting location, etc.) as needed.

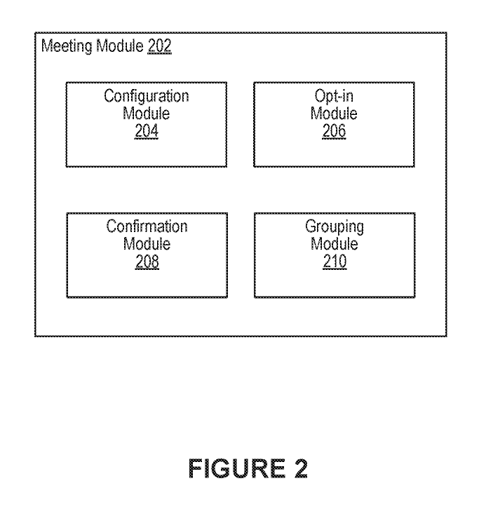

The meeting module 106 is configured to coordinate meetings between various users. In various embodiments, users can opt-in to be matched with other users, for example, for networking purposes and/or joining an activity group (e.g., lunch group). More details regarding the meeting module 106 will be provided below with reference to FIG. 2.

FIG. 2 illustrates an example of a meeting module 202, according to an embodiment of the present disclosure. In some embodiments, the meeting module 106 of FIG. 1 can be implemented as the meeting module 202. As shown in FIG. 2, the meeting module 202 can include a configuration module 204, an opt-in module 206, a confirmation module 208, and a grouping module 210.

The configuration module 204 can be utilized by one or more administrators that manage events (or networking initiatives), for example, for an organization. An event can be created, for example, for employees of an organization, among employees that are located at one or more campuses of the organization, among employees that are associated with certain departments, individuals that are associated with a club or interest-based group, among users that have a certain status (e.g., job seniority level, new employee status, employee interests, etc.), or among any set of individuals.

In some instances, there may be multiple events that are active at any given location (e.g., organization or campus) and each event may be directed to a different category of users. For example, an organization's San Francisco campus can include an event in which new employees (e.g., employees that have been employed by the organization for less than a specified number of months) are assigned to groups for purposes of meeting other new employees over lunch. In this example, the grouping of users is restricted to users that are associated with (e.g., users that work at) the organization's San Francisco campus. Thus, in this example, users that are associated with the organization's San Francisco campus are assigned to groups with other users associated with the San Francisco campus. Another event can involve assigning employees that have opted-in to the event to large lunch groups for purposes of fostering networks and relationships among employees that may not normally have a chance to meet. In another example, an event can be created for assigning student interns to groups with other student interns for a bowling game or tournament.

For each event, an administrator can utilize the configuration module 204 to specify various options including, for example, a name for the event, a description of the event, a group size (e.g., a number of users that should be included in each group), a time at which users are to be matched and assigned to a group (e.g., users can be assigned to lunch groups at 11:45 am on the designated matching days), a meeting time, days of the week on which the matching and group assignments are performed (e.g., Friday), and how often, or frequently, the event will be held (e.g., daily, weekly, bi-weekly, monthly, etc.).

The opt-in module 206 is configured to process user requests to participate in an event. For example, a user can join an event through a page corresponding to the event. This page may be accessible through a social networking system (e.g., the social networking system 630 of FIG. 6), for example. In general, users of the social networking system can navigate to the page to learn more about the event. In some instances, users can also access and/or post content in the page through the social networking system. For example, the page can provide details about the event. In some embodiments, to join the event, the user can select a “subscribe” button through the event page. Other implementations are possible. For example, the user may join the event by sending an email to a designated email addresses (e.g., email address of an administrator).

Once the user has opted-in, or joined, an event, the user is considered to be an active member. In some embodiments, such active members are sent a confirmation on the day(s) on which the event will be held. For example, if the event involves grouping users for lunch, then the confirmation module 208 can send a confirmation request to each active user on the day(s) on which the event will be held (e.g., every Thursday). This request can be sent at any time before the groups are scheduled to meet and such time may be specified through the configuration module 204. In some embodiments, the confirmation request is sent to the user electronically as a calendar invite. The user has the option to accept or reject the invitation. For example, if the user is unable to participate in the event, then the user can simply reject the invitation. As a result, the user will not be included in that day's pool of users that are eligible to be assigned to groups. If the user is able to attend, the user can accept the calendar invite. Once the invite is accepted, the confirmation module 208 adds the user to the pool of users that are eligible to be assigned to a group. Users that have accepted their calendar entry will typically have a calendar entry for the event added to their respective calendars. In some embodiments, the user can decide to sign up for the event for one-time only or for all future events.

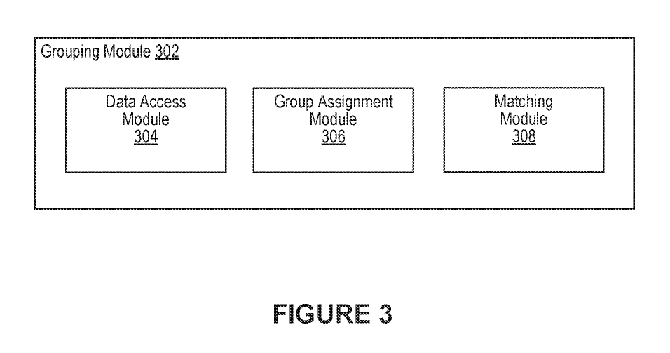

The grouping module 210 can assign users from the pool of eligible users to individual groups. More details regarding the grouping module 210 will be provided below with reference to FIG. 3.

FIG. 3 illustrates an example of a grouping module 302, according to an embodiment of the present disclosure. In some embodiments, the grouping module 210 of FIG. 2 can be implemented as the grouping module 302. As shown in FIG. 3, the grouping module 302 can include a data access module 304, a group assignment module 306, and a matching module 308.

In various embodiments, the data access module 304 can be configured to store and access information about users that are eligible to be grouped or those that have been grouped together. In some embodiments, the data access module 304 can obtain information from a social network graph that is managed by a social networking system (e.g., the social networking system 630 of FIG. 6). Such information can include information about users (e.g., user job title, experience level, interests, duration of employment at an organization, etc.) that can be used to assign the users to groups for events based on various criteria.

Each event can be associated with its own set of configuration options as described above. The group assignment module 306 can assign users to groups based on the configuration options that were specified for the event. The users to be included in a given group can be determined by the matching module 308 as described below. For example, a time at which users are to be assigned to a group may be specified for the event. In the example of grouping users for lunch, the group assignment module 306 may be configured to assign users to groups at 11:45 am on the day(s) on which the event is held. After assigning users to their groups, the group assignment module 306 can send notifications to each of the users providing information about their group (e.g., meeting location, other members of the group, etc.). In some embodiments, the calendar invites that were sent to users to confirm their participation in the event are updated to include their corresponding group information. In some embodiments, the group assignment module 306 may be configured to assign users to groups at multiple times through the day(s) on which the event is being held. Using the example of grouping users for lunch, the group assignment module 306 may be configured to again assign users to groups at 12:05 pm to accommodate users that were late in accepting their calendar invite and, therefore, were not initially included in the pool of users that are eligible for group assignments. In another example, users may be placed into groups to networking meetings over coffee. In this example, the group assignment module 306 may be configured to group users that opted-in throughout the event day(s) at predetermined times and/or intervals (e.g., hourly), for example.

The matching module 308 can be configured to assign users to groups using various approaches depending on the implementation. In one example, an event for new employees of an organization to meet in lunch groups may be configured so that new employees are randomly assigned to groups of two. In instances where there is one remaining user that has not been assigned to a group, the matching module 308 can be configured to randomly assign that user to one of the existing groups. Other approaches for matching users are possible. For example, in some embodiments, users can be assigned to groups based on their job seniority or experience level. In such embodiments, users can be assigned to groups so that at least one group member has a high seniority or experience level than other members of the group, for example. In another example, the users can be assigned to groups so that all, or most, members of a group have a specified seniority or experience level. In some embodiments, users can be assigned to groups based on their employee status. In such embodiments, users can be assigned to groups so that at least one full-time employee of an organization is included in the same group as new, or recently hired, employees of the organization. In some embodiments, users can be assigned to groups based on their interests. In such embodiments, users having the same interests (e.g., long distance running, bicycling, video games, etc.) are assigned to the same group. In another example, users can be assigned to groups based on their social affinity to other users, as determined by the social networking system. This social affinity can provide a measure of how closely connected two users are in the social graph maintained by the social networking system. In such embodiments, users that have a threshold social affinity score between each other can be assigned to the same group. In some instances, the pairing of users for groups can be prioritized or de-prioritized based on various factors. For example, the pairing of users that work together (e.g., same team, project, department, etc.) can be de-prioritized to reduce the likelihood of such users being assigned to the same group. In another example, the pairing of users that have previously been assigned to the same group can be de-prioritized to reduce the likelihood of such users being assigned to the same group again. In some embodiments, the matching module 308 can be configured to create posts in user profiles indicating that the user participated in the event and may include information about other members of the group to which the user was assigned.

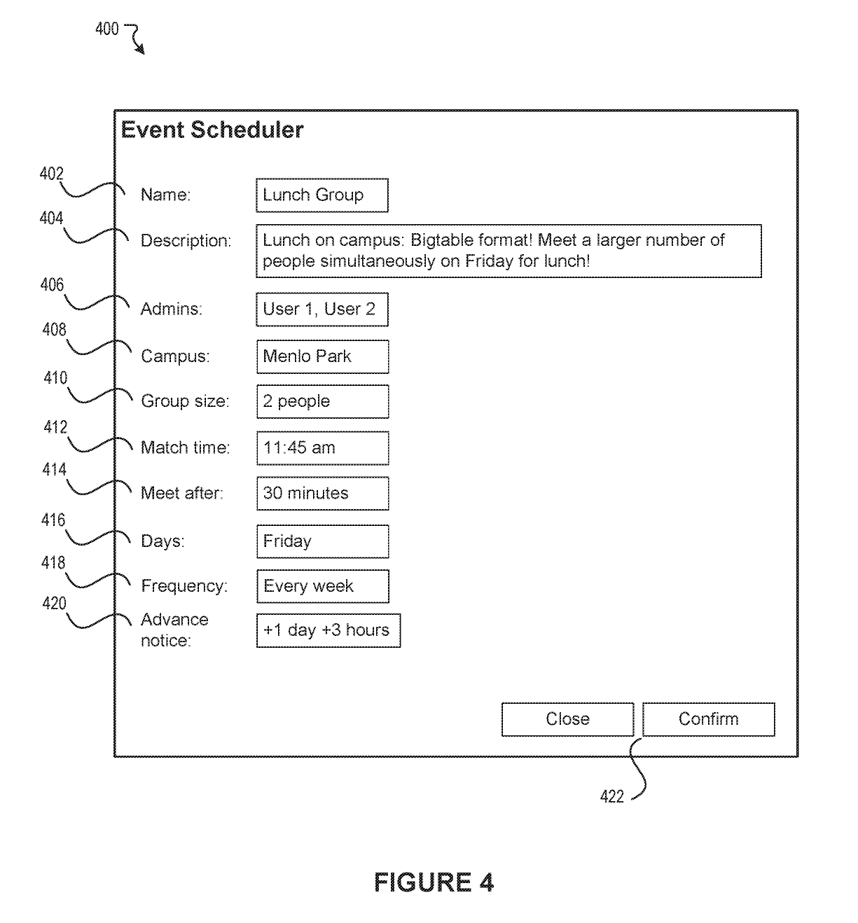

FIG. 4 illustrates an example interface 400 for configuring an event, according to various embodiments of the present disclosure. In various embodiments, the interface 400 can be presented on a display screen of a computing device. The interface 400 may be provided through an application (e.g., a web browser, a social networking application, etc.) running on the computing device. The user operating the computing device can use the interface 400 to create an event for which users that have opted-in will be assigned to groups. In the example of FIG. 4, the interface 400 includes a field 402 in which the user can specify a name for the event (e.g., “Lunch Group”), a field 404 in which the user can specify a description of the event (e.g., “Lunch on campus: Bigtable format! Meet a larger number of people simultaneously on Friday for lunch!”), a field 406 identifying the administrators of the event (e.g., user 1 and user 2), a field 408 for specifying which locations (e.g., campuses) at which the event is to be held (e.g., the Menlo Park campus), a field 410 for specifying the number of users to assign to a group, a field 412 for specifying a time at which users are to be matched and assigned to a group (e.g., users can be assigned to lunch groups at 11:45 am on the designated day(s)), a field 414 for specifying a time or an amount of time after matching at which users are to meet in their respective groups (e.g., 30 minutes after 11:45 am), a field 416 for specifying days of the week on which the event is held (e.g., Friday), a field 418 for specifying how often, or frequently, the event will be held on the designated day(s) (e.g., every week), and a field 420 for specifying how early in advance users should be sent calendar invites for the event (e.g., 1 day and 3 hours before 11:45 am on Friday). Once the options are specified, the user can select the confirm button 422 to create the event.

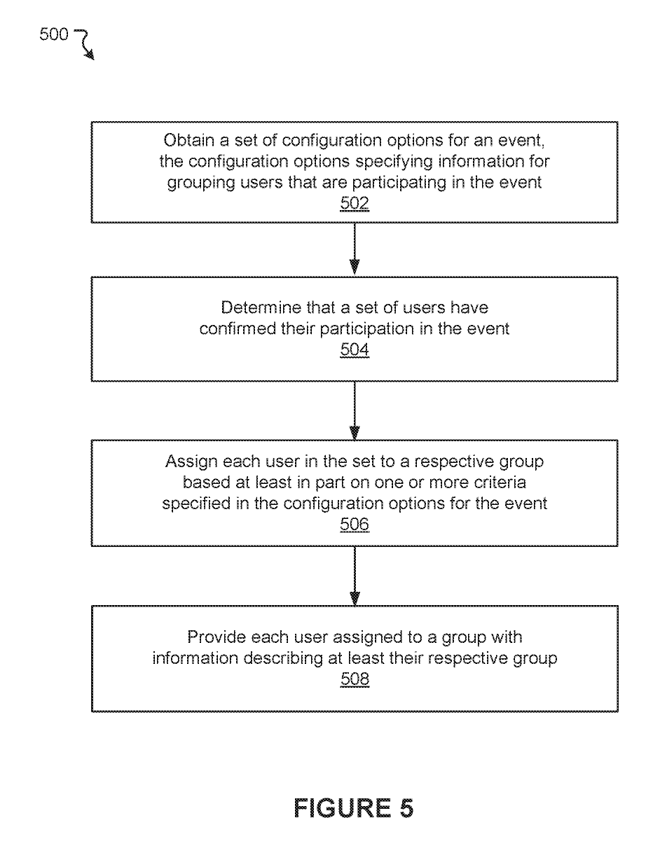

FIG. 5 illustrates another example process 500 for assigning users to groups. It should be appreciated that there can be additional, fewer, or alternative steps performed in similar or alternative orders, or in parallel, within the scope of the various embodiments discussed herein unless otherwise stated. At block 502, a set of configuration options for an event are obtained, the configuration options specifying information for grouping users that are participating in the event. At block 504, a determination is made that a set of users have confirmed their participation in the event. At block 506, each user in the set is assigned to a respective group based at least in part on one or more criteria specified in the configuration options for the event. At block 508, each user assigned to a group is provided with information describing at least their respective group.

It is contemplated that there can be many other uses, applications, and/or variations associated with the various embodiments of the present disclosure. For example, in some cases, user can choose whether or not to opt-in to utilize the disclosed technology. The disclosed technology can also ensure that various privacy settings and preferences are maintained and can prevent private information from being divulged. In another example, various embodiments of the present disclosure can learn, improve, and/or be refined over time.

### Social Networking System—Example Implementation

FIG. 6 illustrates a network diagram of an example system 600 that can be utilized in various scenarios, in accordance with an embodiment of the present disclosure. The system 600 includes one or more user devices 610, one or more external systems 620, a social networking system (or service) 630, and a network 650. In an embodiment, the social networking service, provider, and/or system discussed in connection with the embodiments described above may be implemented as the social networking system 630. For purposes of illustration, the embodiment of the system 600, shown by FIG. 6, includes a single external system 620 and a single user device 610. However, in other embodiments, the system 600 may include more user devices 610 and/or more external systems 620. In certain embodiments, the social networking system 630 is operated by a social network provider, whereas the external systems 620 are separate from the social networking system 630 in that they may be operated by different entities. In various embodiments, however, the social networking system 630 and the external systems 620 operate in conjunction to provide social networking services to users (or members) of the social networking system 630. In this sense, the social networking system 630 provides a platform or backbone, which other systems, such as external systems 620, may use to provide social networking services and functionalities to users across the Internet.

The user device 610 comprises one or more computing devices (or systems) that can receive input from a user and transmit and receive data via the network 650. In one embodiment, the user device 610 is a conventional computer system executing, for example, a Microsoft Windows compatible operating system (OS), Apple OS X, and/or a Linux distribution. In another embodiment, the user device 610 can be a computing device or a device having computer functionality, such as a smart-phone, a tablet, a personal digital assistant (PDA), a mobile telephone, a laptop computer, a wearable device (e.g., a pair of glasses, a watch, a bracelet, etc.), a camera, an appliance, etc. The user device 610 is configured to communicate via the network 650. The user device 610 can execute an application, for example, a browser application that allows a user of the user device 610 to interact with the social networking system 630. In another embodiment, the user device 610 interacts with the social networking system 630 through an application programming interface (API) provided by the native operating system of the user device 610, such as iOS and ANDROID. The user device 610 is configured to communicate with the external system 620 and the social networking system 630 via the network 650, which may comprise any combination of local area and/or wide area networks, using wired and/or wireless communication systems.

In one embodiment, the network 650 uses standard communications technologies and protocols. Thus, the network 650 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 650 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 650 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 610 may display content from the external system 620 and/or from the social networking system 630 by processing a markup language document 614 received from the external system 620 and from the social networking system 630 using a browser application 612. The markup language document 614 identifies content and one or more instructions describing formatting or presentation of the content. By executing the instructions included in the markup language document 614, the browser application 612 displays the identified content using the format or presentation described by the markup language document 614. For example, the markup language document 614 includes instructions for generating and displaying a web page having multiple frames that include text and/or image data retrieved from the external system 620 and the social networking system 630. In various embodiments, the markup language document 614 comprises a data file including extensible markup language (XML) data, extensible hypertext markup language (XHTML) data, or other markup language data. Additionally, the markup language document 614 may include JavaScript Object Notation (JSON) data, JSON with padding (JSONP), and JavaScript data to facilitate data-interchange between the external system 620 and the user device 610. The browser application 612 on the user device 610 may use a JavaScript compiler to decode the markup language document 614.

The markup language document 614 may also include, or link to, applications or application frameworks such as FLASH™ or Unity™ applications, the Silverlight™ application framework, etc.

In one embodiment, the user device 610 also includes one or more cookies 616 including data indicating whether a user of the user device 610 is logged into the social networking system 630, which may enable modification of the data communicated from the social networking system 630 to the user device 610.

The external system 620 includes one or more web servers that include one or more web pages 622a, 622b, which are communicated to the user device 610 using the network 650. The external system 620 is separate from the social networking system 630. For example, the external system 620 is associated with a first domain, while the social networking system 630 is associated with a separate social networking domain. Web pages 622a, 622b, included in the external system 620, comprise markup language documents 614 identifying content and including instructions specifying formatting or presentation of the identified content. As discussed previously, it should be appreciated that there can be many variations or other possibilities.

The social networking system 630 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 630 may be administered, managed, or controlled by an operator. The operator of the social networking system 630 may be a human being, an automated application, or a series of applications for managing content, regulating policies, and collecting usage metrics within the social networking system 630. Any type of operator may be used.

Users may join the social networking system 630 and then add connections to any number of other users of the social networking system 630 to whom they desire to be connected. As used herein, the term “friend” refers to any other user of the social networking system 630 to whom a user has formed a connection, association, or relationship via the social networking system 630. For example, in an embodiment, if users in the social networking system 630 are represented as nodes in the social graph, the term “friend” can refer to an edge formed between and directly connecting two user nodes.

Connections may be added explicitly by a user or may be automatically created by the social networking system 630 based on common characteristics of the users (e.g., users who are alumni of the same educational institution). For example, a first user specifically selects a particular other user to be a friend. Connections in the social networking system 630 are usually in both directions, but need not be, so the terms “user” and “friend” depend on the frame of reference. Connections between users of the social networking system 630 are usually bilateral (“two-way”), or “mutual,” but connections may also be unilateral, or “one-way.” For example, if Bob and Joe are both users of the social networking system 630 and connected to each other, Bob and Joe are each other's connections. If, on the other hand, Bob wishes to connect to Joe to view data communicated to the social networking system 630 by Joe, but Joe does not wish to form a mutual connection, a unilateral connection may be established. The connection between users may be a direct connection; however, some embodiments of the social networking system 630 allow the connection to be indirect via one or more levels of connections or degrees of separation.

In addition to establishing and maintaining connections between users and allowing interactions between users, the social networking system 630 provides users with the ability to take actions on various types of items supported by the social networking system 630. These items may include groups or networks (i.e., social networks of people, entities, and concepts) to which users of the social networking system 630 may belong, events or calendar entries in which a user might be interested, computer-based applications that a user may use via the social networking system 630, transactions that allow users to buy or sell items via services provided by or through the social networking system 630, and interactions with advertisements that a user may perform on or off the social networking system 630. These are just a few examples of the items upon which a user may act on the social networking system 630, and many others are possible. A user may interact with anything that is capable of being represented in the social networking system 630 or in the external system 620, separate from the social networking system 630, or coupled to the social networking system 630 via the network 650.

The social networking system 630 is also capable of linking a variety of entities. For example, the social networking system 630 enables users to interact with each other as well as external systems 620 or other entities through an API, a web service, or other communication channels. The social networking system 630 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 630. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 630 modifies edges connecting the various nodes to reflect the relationships and interactions.

The social networking system 630 also includes user-generated content, which enhances a user's interactions with the social networking system 630. User-generated content may include anything a user can add, upload, send, or “post” to the social networking system 630. For example, a user communicates posts to the social networking system 630 from a user device 610. Posts may include data such as status updates or other textual data, location information, images such as photos, videos, links, music or other similar data and/or media. Content may also be added to the social networking system 630 by a third party. Content “items” are represented as objects in the social networking system 630. In this way, users of the social networking system 630 are encouraged to communicate with each other by posting text and content items of various types of media through various communication channels. Such communication increases the interaction of users with each other and increases the frequency with which users interact with the social networking system 630.

The social networking system 630 includes a web server 632, an API request server 634, a user profile store 636, a connection store 638, an action logger 640, an activity log 642, and an authorization server 644. In an embodiment of the invention, the social networking system 630 may include additional, fewer, or different components for various applications. Other components, such as network interfaces, security mechanisms, load balancers, failover servers, management and network operations consoles, and the like are not shown so as to not obscure the details of the system.

The user profile store 636 maintains information about user accounts, including biographic, demographic, and other types of descriptive information, such as work experience, educational history, hobbies or preferences, location, and the like that has been declared by users or inferred by the social networking system 630. This information is stored in the user profile store 636 such that each user is uniquely identified. The social networking system 630 also stores data describing one or more connections between different users in the connection store 638. The connection information may indicate users who have similar or common work experience, group memberships, hobbies, or educational history. Additionally, the social networking system 630 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 630, such as non-person entities, buckets, cluster centers, images, interests, pages, external systems, concepts, and the like are also stored in the connection store 638.

The social networking system 630 maintains data about objects with which a user may interact. To maintain this data, the user profile store 636 and the connection store 638 store instances of the corresponding type of objects maintained by the social networking system 630. Each object type has information fields that are suitable for storing information appropriate to the type of object. For example, the user profile store 636 contains data structures with fields suitable for describing a user's account and information related to a user's account. When a new object of a particular type is created, the social networking system 630 initializes a new data structure of the corresponding type, assigns a unique object identifier to it, and begins to add data to the object as needed. This might occur, for example, when a user becomes a user of the social networking system 630, the social networking system 630 generates a new instance of a user profile in the user profile store 636, assigns a unique identifier to the user account, and begins to populate the fields of the user account with information provided by the user.

The connection store 638 includes data structures suitable for describing a user's connections to other users, connections to external systems 620 or connections to other entities. The connection store 638 may also associate a connection type with a user's connections, which may be used in conjunction with the user's privacy setting to regulate access to information about the user. In an embodiment of the invention, the user profile store 636 and the connection store 638 may be implemented as a federated database.

Data stored in the connection store 638, the user profile store 636, and the activity log 642 enables the social networking system 630 to generate the social graph that uses nodes to identify various objects and edges connecting nodes to identify relationships between different objects. For example, if a first user establishes a connection with a second user in the social networking system 630, user accounts of the first user and the second user from the user profile store 636 may act as nodes in the social graph. The connection between the first user and the second user stored by the connection store 638 is an edge between the nodes associated with the first user and the second user. Continuing this example, the second user may then send the first user a message within the social networking system 630. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 630 (or, alternatively, in an image maintained by another system outside of the social networking system 630). The image may itself be represented as a node in the social networking system 630. This tagging action may create edges between the first user and the second user as well as create an edge between each of the users and the image, which is also a node in the social graph. In yet another example, if a user confirms attending an event, the user and the event are nodes obtained from the user profile store 636, where the attendance of the event is an edge between the nodes that may be retrieved from the activity log 642. By generating and maintaining the social graph, the social networking system 630 includes data describing many different types of objects and the interactions and connections among those objects, providing a rich source of socially relevant information.

The web server 632 links the social networking system 630 to one or more user devices 610 and/or one or more external systems 620 via the network 650. The web server 632 serves web pages, as well as other web-related content, such as Java, JavaScript, Flash, XML, and so forth. The web server 632 may include a mail server or other messaging functionality for receiving and routing messages between the social networking system 630 and one or more user devices 610. The messages can be instant messages, queued messages (e.g., email), text and SMS messages, or any other suitable messaging format.

The API request server 634 allows one or more external systems 620 and user devices 610 to call access information from the social networking system 630 by calling one or more API functions. The API request server 634 may also allow external systems 620 to send information to the social networking system 630 by calling APIs. The external system 620, in one embodiment, sends an API request to the social networking system 630 via the network 650, and the API request server 634 receives the API request. The API request server 634 processes the request by calling an API associated with the API request to generate an appropriate response, which the API request server 634 communicates to the external system 620 via the network 650. For example, responsive to an API request, the API request server 634 collects data associated with a user, such as the user's connections that have logged into the external system 620, and communicates the collected data to the external system 620. In another embodiment, the user device 610 communicates with the social networking system 630 via APIs in the same manner as external systems 620.

The action logger 640 is capable of receiving communications from the web server 632 about user actions on and/or off the social networking system 630. The action logger 640 populates the activity log 642 with information about user actions, enabling the social networking system 630 to discover various actions taken by its users within the social networking system 630 and outside of the social networking system 630. Any action that a particular user takes with respect to another node on the social networking system 630 may be associated with each user's account, through information maintained in the activity log 642 or in a similar database or other data repository. Examples of actions taken by a user within the social networking system 630 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 630, the action is recorded in the activity log 642. In one embodiment, the social networking system 630 maintains the activity log 642 as a database of entries. When an action is taken within the social networking system 630, an entry for the action is added to the activity log 642. The activity log 642 may be referred to as an action log.

Additionally, user actions may be associated with concepts and actions that occur within an entity outside of the social networking system 630, such as an external system 620 that is separate from the social networking system 630. For example, the action logger 640 may receive data describing a user's interaction with an external system 620 from the web server 632. In this example, the external system 620 reports a user's interaction according to structured actions and objects in the social graph.

Other examples of actions where a user interacts with an external system 620 include a user expressing an interest in an external system 620 or another entity, a user posting a comment to the social networking system 630 that discusses an external system 620 or a web page 622a within the external system 620, a user posting to the social networking system 630 a Uniform Resource Locator (URL) or other identifier associated with an external system 620, a user attending an event associated with an external system 620, or any other action by a user that is related to an external system 620. Thus, the activity log 642 may include actions describing interactions between a user of the social networking system 630 and an external system 620 that is separate from the social networking system 630.

The authorization server 644 enforces one or more privacy settings of the users of the social networking system 630. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 620, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 620. One embodiment allows the specification of the set of entities to comprise an enumeration of entities. For example, the user may provide a list of external systems 620 that are allowed to access certain information. Another embodiment allows the specification to comprise a set of entities along with exceptions that are not allowed to access the information. For example, a user may allow all external systems 620 to access the user's work information, but specify a list of external systems 620 that are not allowed to access the work information. Certain embodiments call the list of exceptions that are not allowed to access certain information a “block list”. External systems 620 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 644 contains logic to determine if certain information associated with a user can be accessed by a user's friends, external systems 620, and/or other applications and entities. The external system 620 may need authorization from the authorization server 644 to access the user's more private and sensitive information, such as the user's work phone number. Based on the user's privacy settings, the authorization server 644 determines if another user, the external system 620, an application, or another entity is allowed to access information associated with the user, including information about actions taken by the user.

In some embodiments, the social networking system 630 can include a scheduling module 646. The scheduling 646 can, for example, be implemented as the scheduling module 102 of FIG. 1. As discussed previously, it should be appreciated that there can be many variations or other possibilities.

### Hardware Implementation

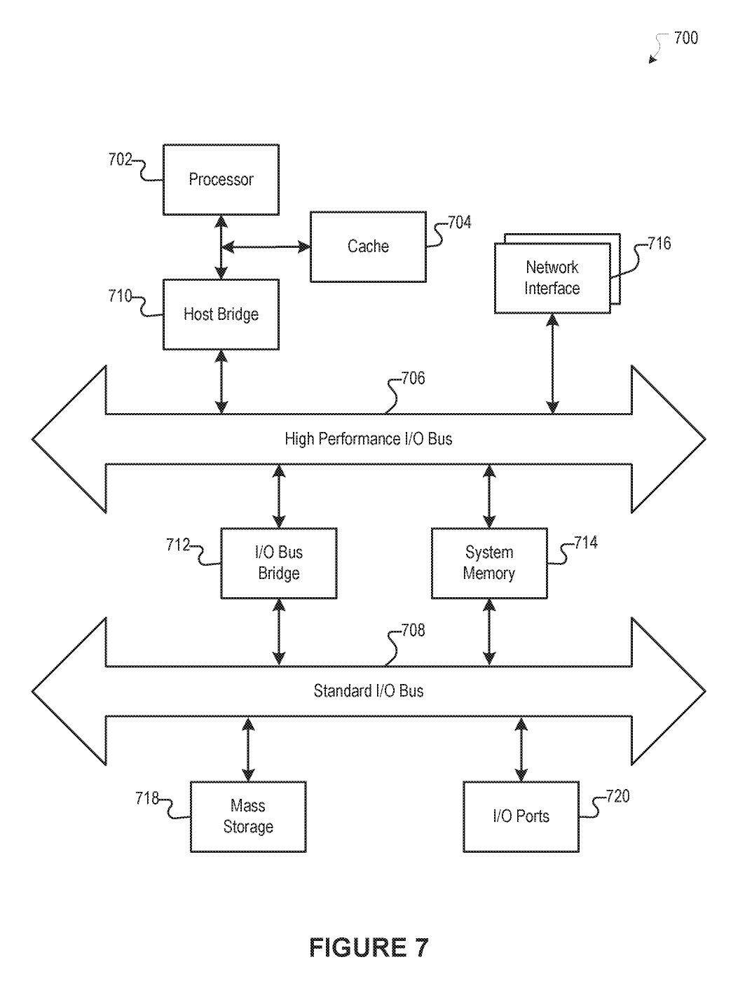

The foregoing processes and features can be implemented by a wide variety of machine and computer system architectures and in a wide variety of network and computing environments. FIG. 7 illustrates an example of a computer system 700 that may be used to implement one or more of the embodiments described herein in accordance with an embodiment of the invention. The computer system 700 includes sets of instructions for causing the computer system 700 to perform the processes and features discussed herein. The computer system 700 may be connected (e.g., networked) to other machines. In a networked deployment, the computer system 700 may operate in the capacity of a server machine or a client machine in a client-server network environment, or as a peer machine in a peer-to-peer (or distributed) network environment. In an embodiment of the invention, the computer system 700 may be the social networking system 630, the user device 610, and the external system 720, or a component thereof. In an embodiment of the invention, the computer system 700 may be one server among many that constitutes all or part of the social networking system 630.

The computer system 700 includes a processor 702, a cache 704, and one or more executable modules and drivers, stored on a computer-readable medium, directed to the processes and features described herein. Additionally, the computer system 700 includes a high performance input/output (I/O) bus 706 and a standard I/O bus 708. A host bridge 710 couples processor 702 to high performance I/O bus 706, whereas I/O bus bridge 712 couples the two buses 706 and 708 to each other. A system memory 714 and one or more network interfaces 716 couple to high performance I/O bus 706. The computer system 700 may further include video memory and a display device coupled to the video memory (not shown). Mass storage 718 and I/O ports 720 couple to the standard I/O bus 708. The computer system 700 may optionally include a keyboard and pointing device, a display device, or other input/output devices (not shown) coupled to the standard I/O bus 708. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 700, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 700 are described in greater detail below. In particular, the network interface 716 provides communication between the computer system 700 and any of a wide range of networks, such as an Ethernet (e.g., IEEE 802.3) network, a backplane, etc. The mass storage 718 provides permanent storage for the data and programming instructions to perform the above-described processes and features implemented by the respective computing systems identified above, whereas the system memory 714 (e.g., DRAM) provides temporary storage for the data and programming instructions when executed by the processor 702. The I/O ports 720 may be one or more serial and/or parallel communication ports that provide communication between additional peripheral devices, which may be coupled to the computer system 700.

The computer system 700 may include a variety of system architectures, and various components of the computer system 700 may be rearranged. For example, the cache 704 may be on-chip with processor 702. Alternatively, the cache 704 and the processor 702 may be packed together as a “processor module”, with processor 702 being referred to as the “processor core”. Furthermore, certain embodiments of the invention may neither require nor include all of the above components. For example, peripheral devices coupled to the standard I/O bus 708 may couple to the high performance I/O bus 706. In addition, in some embodiments, only a single bus may exist, with the components of the computer system 700 being coupled to the single bus. Moreover, the computer system 700 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 700 that, when read and executed by one or more processors, cause the computer system 700 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 700, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 702. Initially, the series of instructions may be stored on a storage device, such as the mass storage 718. However, the series of instructions can be stored on any suitable computer readable storage medium. Furthermore, the series of instructions need not be stored locally, and could be received from a remote storage device, such as a server on a network, via the network interface 716. The instructions are copied from the storage device, such as the mass storage 718, into the system memory 714 and then accessed and executed by the processor 702. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 700 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
obtaining, by a social networking system, a set of configuration options for an event, the configuration options specifying information for grouping users that are participating in the event;
determining, by the social networking system, that a set of users have confirmed their participation in the event;
assigning, by the social networking system, each user in the set to a respective group based at least in part on one or more criteria specified in the configuration options for the event; and
providing, by the social networking system, each user assigned to a group with information describing at least their respective group.

2. The computer-implemented method of claim 1, wherein the configuration options specify one or more of: a geographic location at which the event is being held, a number of users to include in a group, one or more days on which the event is held, how frequently the event is held, and at least one approach for assigning users to groups.

3. The computer-implemented method of claim 1, wherein determining that a set of users have confirmed their participation in the event further comprises:
sending, by the social networking system, a calendar invite for the event to each user that has opted-in to attend the event; and
determining, by the social networking system, the set of users that have accepted their respective calendar invite.

4. The computer-implemented method of claim 1, wherein assigning each user in the set to a respective group based at least in part on one or more criteria specified in the configuration options for the event further comprises:
assigning, by the social networking system, at least one user having a first job title with at least one user having a second job title to the same group.

5. The computer-implemented method of claim 1, wherein assigning each user in the set to a respective group based at least in part on one or more criteria specified in the configuration options for the event further comprises:
assigning, by the social networking system, at least one user having a first duration of employment with an organization with at least one user having a second duration of employment with the organization to the same group.

6. The computer-implemented method of claim 1, wherein assigning each user in the set to a respective group based at least in part on one or more criteria specified in the configuration options for the event further comprises:
determining, by the social networking system, respective interests for at least some of the users in the set based at least in part on information provided in the respective social networking profiles of the users; and
assigning, by the social networking system, at least one first user and at least one second user having at least one matching interest to the same group.

7. The computer-implemented method of claim 1, wherein assigning each user in the set to a respective group based at least in part on one or more criteria specified in the configuration options for the event further comprises:
determining, by the social networking system, respective social affinity scores between at least some of the users in the set based at least in part on a social graph managed by the social networking system; and
assigning, by the social networking system, at least one first user and at least one second user having at least one a threshold social affinity score to the same group.

8. The computer-implemented method of claim 1, wherein assigning each user in the set to a respective group based at least in part on one or more criteria specified in the configuration options for the event further comprises:
determining, by the social networking system, that at least one first user and at least one second user have previously been assigned to the same group; and
assigning, by the social networking system, the at least one first user to a group that is different from a group to which the at least one second user is assigned.

9. The computer-implemented method of claim 1, wherein assigning each user in the set to a respective group based at least in part on one or more criteria specified in the configuration options for the event further comprises:
determining, by the social networking system, that at least one first user and at least one second user are employees that work in the same department; and
assigning, by the social networking system, the at least one first user to a group that is different from a group to which the at least one second user is assigned.

10. The computer-implemented method of claim 1, wherein providing each user assigned to a group with information describing at least their respective group further comprises:
updating, by the social networking system, respective calendar entries for the event that were accepted by the set of users, wherein a calendar entry of a user is updated to include information describing the respective group to which the user was assigned.

11. A system comprising:
at least one processor; and
a memory storing instructions that, when executed by the at least one processor, cause the system to perform:
obtaining a set of configuration options for an event, the configuration options specifying information for grouping users that are participating in the event;
determining that a set of users have confirmed their participation in the event;
assigning each user in the set to a respective group based at least in part on one or more criteria specified in the configuration options for the event; and
providing each user assigned to a group with information describing at least their respective group.

12. The system of claim 11, wherein the configuration options specify one or more of: a geographic location at which the event is being held, a number of users to include in a group, one or more days on which the event is held, how frequently the event is held, and at least one approach for assigning users to groups.

13. The system of claim 11, wherein determining that a set of users have confirmed their participation in the event further causes the system perform:
sending a calendar invite for the event to each user that has opted-in to attend the event; and
determining the set of users that have accepted their respective calendar invite.

14. The system of claim 11, wherein assigning each user in the set to a respective group based at least in part on one or more criteria specified in the configuration options for the event further causes the system perform:
assigning at least one user having a first job title with at least one user having a second job title to the same group.

15. The system of claim 11, wherein assigning each user in the set to a respective group based at least in part on one or more criteria specified in the configuration options for the event further causes the system perform:
assigning at least one user having a first duration of employment with an organization with at least one user having a second duration of employment with the organization to the same group.

16. A non-transitory computer-readable storage medium including instructions that, when executed by at least one processor of a computing system, cause the computing system to perform a method comprising:
obtaining a set of configuration options for an event, the configuration options specifying information for grouping users that are participating in the event;
determining that a set of users have confirmed their participation in the event;
assigning each user in the set to a respective group based at least in part on one or more criteria specified in the configuration options for the event; and
providing each user assigned to a group with information describing at least their respective group.

17. The non-transitory computer-readable storage medium of claim 16, wherein the configuration options specify one or more of: a geographic location at which the event is being held, a number of users to include in a group, one or more days on which the event is held, how frequently the event is held, and at least one approach for assigning users to groups.

18. The non-transitory computer-readable storage medium of claim 16, wherein determining that a set of users have confirmed their participation in the event further causes the computing system perform:
sending a calendar invite for the event to each user that has opted-in to attend the event; and
determining the set of users that have accepted their respective calendar invite.

19. The non-transitory computer-readable storage medium of claim 16, wherein assigning each user in the set to a respective group based at least in part on one or more criteria specified in the configuration options for the event further causes the computing system perform:
assigning at least one user having a first job title with at least one user having a second job title to the same group.

20. The non-transitory computer-readable storage medium of claim 16, wherein assigning each user in the set to a respective group based at least in part on one or more criteria specified in the configuration options for the event further causes the computing system perform:
assigning at least one user having a first duration of employment with an organization with at least one user having a second duration of employment with the organization to the same group.
